(19) United States
(12) Patent Application Publication
(10) Pub. No.: US 2007/0116815 A1
(43) Pub. Date: May 24, 2007

(54) Cooking apparatus and method of the same

(75) Inventors: Kwang Keun Kim, Yongin-Si (KR); Jeong Han Kim, Suwon-Si (KR); Suk Hee Lee, Suwon-Si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/435,793

(22) Filed: May 18, 2006

(30) Foreign Application Priority Data
Nov. 19, 2005 (KR) 10-2005-0111063

(51) Int. Cl. A23C 3/00

(52) U.S. Cl. 426/523

(57) ABSTRACT

A cooking apparatus and method of the same. The cooking method includes reading and interpreting a bar code, indicated on a package of the food to be cooked, storing kinds of food and cooking information for the food to be cooked, sensing the temperature of the food to be cooked to confirm the stored state of the food to be cooked, and, thawing the food to be cooked according to thawing information when the kind of food for the food to be cooked is food designed to be chilled and the food to be cooked is frozen, and performing a cooking process based on the cooking information.

### CROSS-REFERENCE TO RELATED APPLICATIONS

This application claims the benefit of Korean Patent Application No. 10-2005-0111063, filed on Nov. 19, 2005 in the Korean Intellectual Property Office, the disclosure of which is incorporated herein by reference.

### BACKGROUND OF THE INVENTION

1. Field of the Invention

The present invention relates to a cooking apparatus and method of the same. More particularly, to a cooking apparatus and method that is capable of cooking food after adding or subtracting a thawing process based on the current storage state of the food to be cooked when the current storage state of the food is different from the predetermined storage state of the food.

2. Description of the Related Art

Generally, conventional cooking apparatuses are devices that cook food using various heating sources. Based on heating sources, cooking apparatuses are classified into several types of cooking apparatuses. For example, a microwave oven is a cooking apparatus that cooks food using microwaves. In the conventional microwave oven, a user directly inputs a cooking time, a cooking mode, and kinds of food to be cooked through the use of a key input unit formed at a front panel of the microwave oven. In other words, it is necessary that the user manually input cooking information. Consequently, appropriate cooking conditions are not easily and conveniently set.

Thus, a microwave oven has been developed which is capable of reading a bar code storing cooking information, which is attached to a food package, and cooking food based on the cooking information stored in the bar code. Such a microwave oven is disclosed in Korean Unexamined Patent Publication No. 2001-0010530. Also, another microwave oven has developed that is capable of storing cooking information on various kinds of food in a memory and, when a user selects food to be cooked, cooking the food based on the cooking information stored in the memory.

However, the microwave oven using the bar code has a problem in that, when food, designed to be chilled, is frozen, the food is cooked based on the cooking conditions suitable to the chilled state, and therefore, the food is not appropriately cooked. Specifically, the cooking conditions stored in the bar code printed on the food package are set such that the food can be optimally cooked when it is chilled. Consequently, when the wrongly frozen food, which should have been chilled, is cooked according to the cooking conditions stored in the bar code without leaving the food to thaw before cooking, the food is not optimally cooked.

In order to solve the above-mentioned problem, Korean Patent Application No. 2004-53090 (filed Jul. 8, 2004) proposes a cooking apparatus and method, wherein, when food to be cooked, which is designed to be chilled is frozen, the food is not directly cooked based on cooking conditions read by a bar-code reader, but the food is thawed to change the state of the food and then cooked.

However, the proposed cooking apparatus and method has been developed in order to solve only the problem in that, when food, which is designed to be chilled is frozen, and is directly cooked, the food is not appropriately cooked. Consequently, the proposed cooking apparatus and method cannot solve a problem in that, when food, which is designed to be frozen, is chilled or stored at room temperature, and is directly cooked, the food is not appropriately cooked. In this case, the food designed to be frozen does not need to be thawed before cooking, but the food is thawed based on the cooking information of the food designed to be frozen, including thawing information, and is then cooked. As a result, the food is overcooked.

When food is selected and cooked in the microwave oven having cooking information on various kinds of food stored in the memory, the following problem is raised. When the food, designed to be chilled, is frozen, or the food, designed to be frozen, is chilled, and is directly cooked, the food is not appropriately cooked. This is because, when cooking information to be stored in a memory is set by microwave oven manufacturers, cooking information of food designed to be chilled is set on the premise that the food designed to be chilled is generally in chilled storage, and cooking information (including a thawing process) of food designed to be frozen is set on the premise that the food designed to be frozen is generally in frozen storage.

### SUMMARY OF THE INVENTION

Accordingly, it is an aspect of the present invention to provide a cooking apparatus and method that is capable of cooking food after adding or subtracting a thawing process when the food is in the state that it is not appropriate to cook in the case that the food is automatically cooked based on cooking information stored in a bar code or a memory of the cooking apparatus.

Additional aspects and/or advantages of the invention will be set forth in part in the description which follows and, in part, will be apparent from the description, or may be learned by practice of the invention.

The foregoing and/or other aspects of the present invention are achieved by providing a cooking method including reading and interpreting a bar code, indicated on a package of the food to be cooked, storing kinds of food and cooking information for the food to be cooked, sensing a temperature of the food to be cooked to confirm the stored state of the food to be cooked, and thawing the food to be cooked according to thawing information, when the kind of food for the food to be cooked is food designed to be chilled and the food to be cooked is frozen, and performing a cooking process based on the cooking information.

The cooking method further includes determining that the food to be cooked is in a chilled storage (i.e., a refrigerating part of a refrigerator, for example) when the temperature of the food to be cooked is within a predetermined chilled storage range, and determining that the food to be cooked is in a frozen storage (i.e., a freezing part of a refrigerator, for example) when the temperature of the food to be cooked is within a predetermined frozen storage range.

The thawing information includes a thawing time set for each food to be cooked or a power level of a cooking apparatus.

The thawing information is stored in the bar code.

The cooking method further includes, setting the thawing information for each food to be cooked, and storing the thawing information in a memory of a cooking apparatus, storing food name information in the bar code, and confirming the thawing information of the food to be cooked by interpreting the bar code in the cooking apparatus to confirm the name of the food to be cooked, and searching for thawing information of the food to be cooked having the corresponding food name in the memory.

The cooking method further includes performing a cooking process based on the cooking information without thawing the food to be cooked when the kind of food for the food to be cooked is food designed to be chilled and the food to be cooked is chilled.

It is another aspect of the present invention to provide a cooking method including reading and interpreting a bar code, indicated on a package of food to be cooked, storing kinds of food, cooking information, and thawing information for the food to be cooked, sensing the temperature of the food to be cooked to confirm the stored state of the food to be cooked, and performing a cooking process based on the other cooking information without thawing the food to be cooked when the kind of food for the food to be cooked is food designed to be frozen and the food to be cooked is chilled.

The cooking method further includes determining that the food to be cooked is in a chilled storage when the temperature of the food to be cooked is within a predetermined chilled storage range, and determining that the food to be cooked is in a frozen storage when the temperature of the food to be cooked is within a predetermined frozen storage range.

The cooking method further includes thawing the food to be cooked according to the thawing information when the kind of food for the food to be cooked is food designed to be frozen and the food to be cooked is frozen, and performing a cooking process based on the cooking information.

It is another aspect of the present invention to provide a cooking apparatus including a bar-code reader to read a bar code, indicated on a package of food to be cooked, storing kinds of food and cooking information for the food to be cooked, a temperature sensor to sense the temperature of the food to be cooked, a control unit to interpret the kind of food and the cooking information read by the bar-code reader, to confirm the stored state of the food to be cooked using the temperature of the food to be cooked, and, to control the food to be thawed and cooked based on the cooking information when the food to be cooked, designed to be chilled, is frozen, and a driving unit to perform a cooking process according to a control command transmitted from the control unit.

The control unit further determines that the food to be cooked is in the chilled storage when the temperature of the food to be cooked is within a predetermined chilled storage range and in frozen storage when the temperature of the food to be cooked is within a predetermined frozen storage range.

The thawing information includes thawing time set for each food to be cooked or power level of the driving unit.

The thawing information is stored in the bar code.

The cooking apparatus further includes a memory, wherein the thawing information is set for each food to be cooked and stored in the memory:

It is yet another aspect of the present invention to provide a cooking apparatus including a bar-code reader to read a bar code, indicated on a package of food to be cooked, storing kinds of food, cooking information, and thawing information for the food to be cooked, a temperature sensor to sense the temperature of the food to be cooked, a control unit to interpret the cooking information and the kinds of food read by the bar-code reader, to confirm the stored state of the food to be cooked using the temperature of the food to be cooked, and to control the food to be cooked based on the cooking information without thawing the food to be cooked when the kind of food for the food to be cooked is food designed to be frozen and the food to be cooked is chilled, and a driving unit to perform a cooking process according to a control command from the control unit.

The control unit further determines that the food to be cooked is in a chilled storage when the temperature of the food to be cooked is within a predetermined chilled storage range and determines that the food to be cooked is in a frozen storage when the temperature of the food to be cooked is within a predetermined frozen storage range.

It is yet another aspect of the present invention to provide a cooking method including storing kinds of food, cooking information, and thawing information for food to be cooked in a memory of a cooking apparatus; searching for the cooking information of food to be cooked, which is selected by a user, in the memory, sensing a temperature of the food to be cooked to confirm the stored state of the food to be cooked; and, when the kind of food for the food to be cooked is food designed to be chilled and the food to be cooked is frozen, thawing the food to be cooked according to the thawing information stored in the memory, and performing a cooking process based on the cooking information stored in the memory.

The cooking method further includes performing a cooking process based on the cooking information without thawing the food to be cooked when the kind of food for the food to be cooked is food designed to be chilled and the food to be cooked is chilled.

It is another aspect of the present invention to provide a cooking method including storing kinds of food, cooking information, and thawing information for food to be cooked in a memory of a cooking apparatus; searching for the cooking information of food to be cooked, which is selected by a user, in the memory, sensing a temperature of the food to be cooked to confirm the stored state of the food to be cooked, and performing a cooking process based on the other cooking information stored in the memory excluding the thawing information when the kind of food for the food to be cooked is food designed to be frozen and the food to be cooked is chilled.

The cooking method further includes determining that the food to be cooked is in a chilled storage when the temperature of the food to be cooked is within a predetermined chilled storage range, and determining that the food to be cooked is in a frozen storage when the temperature of the food to be cooked is within a predetermined frozen storage range.

It is another aspect of the present invention to provide a cooking apparatus including a memory to store kinds of food, cooking information, and thawing information for food to be cooked, a temperature sensor to sense the temperature of the food to be cooked; a control unit to control the food to be thawed according to the thawing information and then the food to be cooked based on the cooking information, when the kind of food for the food to be cooked is food designed to be chilled and the food to be cooked is frozen; and a driving unit to perform a cooking process according to a control command from the control unit.

It is yet another aspect of the present invention to provide a cooking apparatus including a memory to store kinds of food, cooking information, and thawing information for food to be cooked, a temperature sensor to sense the temperature of the food to be cooked, a control unit to control the food to be cooked based on the other cooking information excluding the thawing information without thawing the food to be cooked, when the kind of food for the food to be cooked is food designed to be frozen and the food to be cooked is chilled, and a driving unit to perform a cooking process according to a control command from the control unit.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a perspective view illustrating a microwave oven according to a first embodiment of the present invention;

FIG. 2 is a control block diagram of the microwave oven shown in FIG. 1;

FIG. 3 is a view illustrating cooking information stored in a bar code attached to a package of food designed to be chilled or frozen according to an embodiment of the present invention;

FIG. 4 is a view illustrating cooking information stored in a bar code only attached to a package of food designed to be chilled according to an embodiment of the present invention;

FIG. 5 is a flow chart illustrating a cooking method according to a first embodiment of the present invention;

FIG. 6 is a perspective view illustrating a microwave oven according to a second embodiment of the present invention;

FIG. 7 is a control block diagram of the microwave oven shown in FIG. 6; and

FIG. 8 is a flow chart illustrating a cooking method according to a second embodiment of the present invention.

### DETAILED DESCRIPTION OF THE PREFERRED EMBODIMENTS

Reference will now be made in detail to the embodiment of the present invention, examples of which are illustrated in the accompanying drawings, wherein like reference numerals refer to like elements throughout. The embodiments are described below to explain the present invention by referring to the figures.

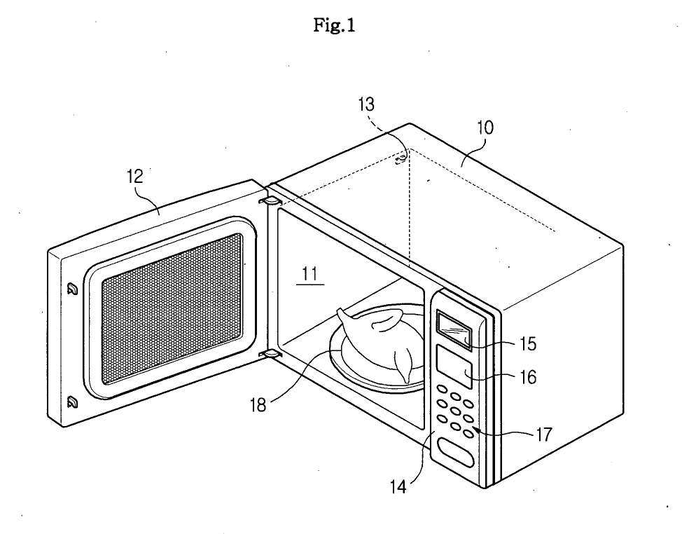

In FIG. 1, a microwave oven according to a first embodiment of the present invention, comprises a cooking chamber 11 disposed in an oven body 10, a door 12 hingedly connected to the oven body 10 to open and close an opening part of the cooking chamber 11, a temperature sensor mounted in the cooking chamber 11, and a front panel 14 disposed at a right front part of the oven body 10. The present invention is not limited to any particular type of cooking apparatus, and may vary accordingly.

The temperature sensor 13 is provided to sense the temperature of food to be cooked. In this embodiment, the temperature sensor 13 is a non-contact type temperature sensor (for example, an infrared temperature device), which is mounted at the wall of the cooking chamber 11 to sense the temperature of food to be cooked without contacting the food to be cooked. However, the temperature sensor 13 is not limited to the non-contact type temperature sensor, and may vary as necessary. For example, the temperature of food to be cooked may be sensed by a contact type temperature sensor, such as a thermocouple temperature sensor or a resistance temperature device (RTD), mounted at a tray 18, on which the food to be cooked is placed.

The front panel 14 comprises a display unit 15 disposed at an upper part thereof to display an operation of the microwave oven, a built-in bar-code reader 16 disposed below the display unit 15 to read a bar code, and an input unit 17 disposed below the bar-code reader 16. The input unit 17 comprises a plurality of input buttons.

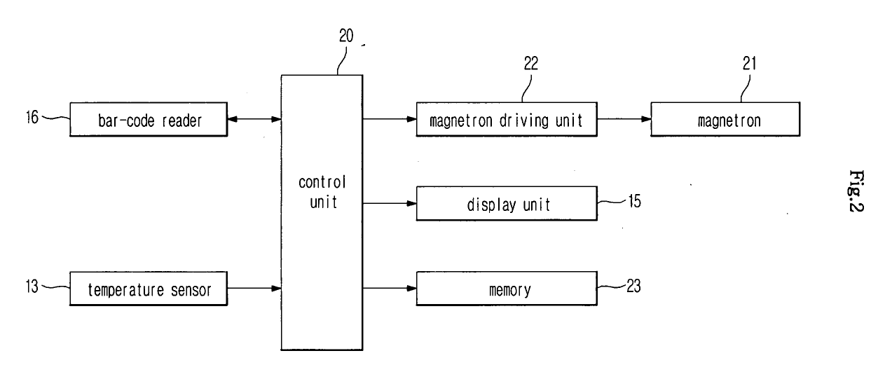

As shown in FIG. 2, the microwave oven shown in FIG. 1 further comprises a magnetron-driving unit 22 to drive a magnetron 21 that generates microwaves to be supplied to the cooking chamber 11, a control unit 20 to interpret a bar code read by the bar-code reader 16 to confirm cooking information stored in the bar code and control the respective components of the microwave oven such that the food is cooked according to the cooking information, and a memory 23 to store a chilled storage range, a frozen storage range, and thawing information of food designed to be chilled.

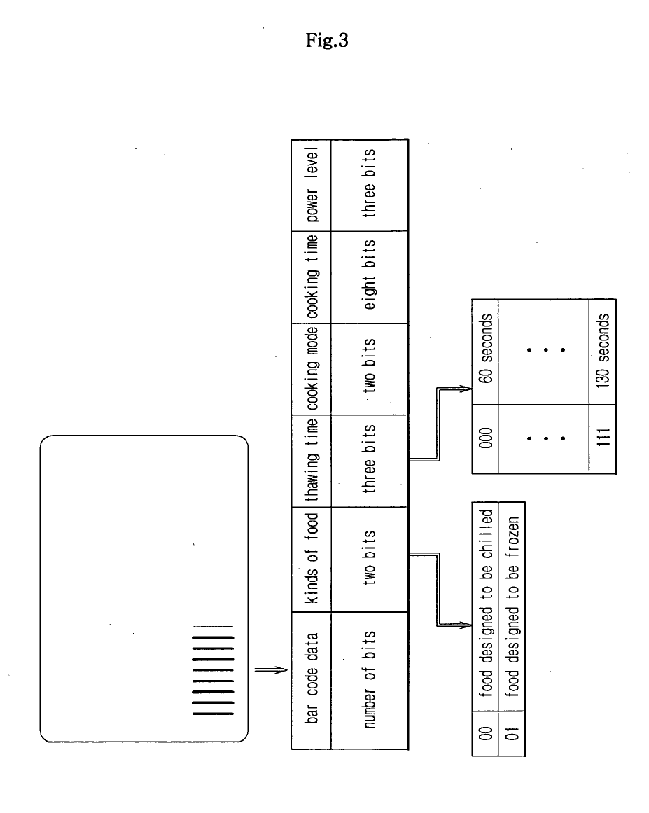

Bar codes used in this embodiment may be classified into two types, for example, one of which is shown in FIG. 3. The bar code shown in FIG. 3 stores kinds of food, thawing time, and various cooking conditions, and is used for both food designed to be chilled and food designed to be frozen.

Based on kinds of food, food having a printed bar code is classified into food designed to be chilled, which is necessary to be kept in a chilled storage, and food designed to be frozen, which is necessary to be kept in a frozen storage. Different bar code values are given according to the different kinds of food. For example, two bits are assigned to the bar code to store the kinds of food. When the two-bit bar code is read “00,” it is determined that the food is designed to be chilled. When the two-bit bar code is read “01,” it is determined that the food is designed to be frozen.

The thawing time, which is a kind of thawing information, is set to thaw food designed to be chilled or frozen before the food is cooked. For example, three bits are assigned to the bar code for storing the thawing time. When the bar code is read “000,” it is determined that the thawing time is 60 seconds. When the bar code is read “111,” it is determined that the thawing time is 130 seconds. However, the present invention is not limited the any particular time amount, and may vary as necessary.

In this embodiment, an output of the magnetron during thawing is uniform, and the thawing time is changed depending upon food to be cooked. Alternatively, it is possible to store both thawing time and power level during thawing (the level of power supplied to the magnetron during thawing) in the bar code such that the power level during thawing as well as the thawing time can be changed depending upon food to be cooked.

The cooking conditions comprise a cooking mode, such as cooking by microwaves or grill cooking by an electric heater mounted in the microwave oven, a cooking time, and a power level to decide the output of the magnetron during cooking. %

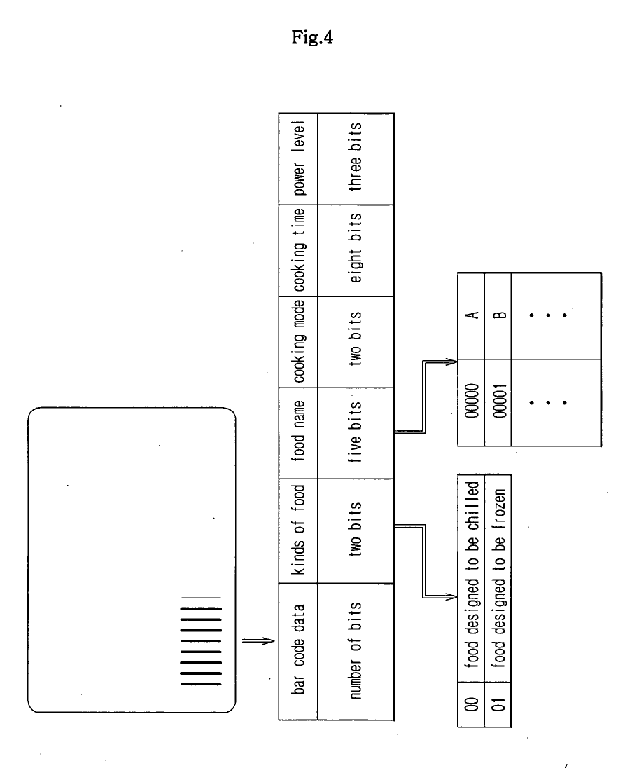

The other type of bar code used in this embodiment is shown in FIG. 4. The bar code shown in FIG. 4 stores kinds of food, food name, and various cooking conditions, and is used for only food designed to be chilled. In this case, a description of the kinds of food and the cooking conditions is the same as what has previously described with reference to FIG. 3. The present invention is not limited to any particular type of information being stored in the bar code, and may vary as necessary.

As shown in FIG. 4, the food name is information for the control unit to confirm food to be cooked. In other words, the food name serves as identification (ID) of the food to be cooked. For example, five bits are assigned to the bar code to store the food name. When the five-bit bar code is read “00 000,” it is indicated that the food to be cooked is A. When the five-bit bar code is read “00 001,” it is indicated that the food to be cooked is B.

The control unit 20 stores interpreting rules to read the bar codes shown in FIGS. 3 and 4. Specifically, the interpreting rules prescribe what cooking information each line of the bar code stores, and the detailed contents of the cooking information or the thawing information corresponding to the value of the read bar code.

The chilled storage range and the frozen storage range stored in the memory 23 are temperature ranges set to determine when food to be cooked is in chilled storage or in frozen storage. The chilled storage range is set to 0° or more, and the frozen storage range is set to below 0°. However, the chilled storage range and the frozen storage range may be set differently in consideration of the fact that temperature ranges for chilling and freezing compartments of various refrigerators are not the same.

The thawing information stored in the memory 23 is provided such that no thawing information is stored in a bar code attached to a package of food designed to be chilled (i.e., the bar code as shown in FIG. 4 is attached to the food designed to be chilled). The thawing information includes a thawing time and a power level during thawing, as indicated in Table 1 shown below. The thawing information is given for each food designed to be chilled. The power level indicated in Table 1 is a power level supplied to the magnetron during thawing, which is expressed by percentage of the maximum power.

TABLE 1

Thawing information

| Food name | Thawing time | Power level |
|---|---|---|
| A | 160 seconds | 50% |
| B | 220 seconds | 60% |
| . . . | . . . | . . . |

A flash memory having easy input and output of data is used, for example, as the above-mentioned memory such that, whenever new food designed to be chilled comes into the market, thawing information of the food can be easily stored in the memory. In this case, the thawing information stored in the flash memory may be updated in various manners, an example of which is disclosed in Korean Unexamined Patent Publication No. 2002-78335, entitled Data Processing Method of Internet Microwave Oven Memory Pack.

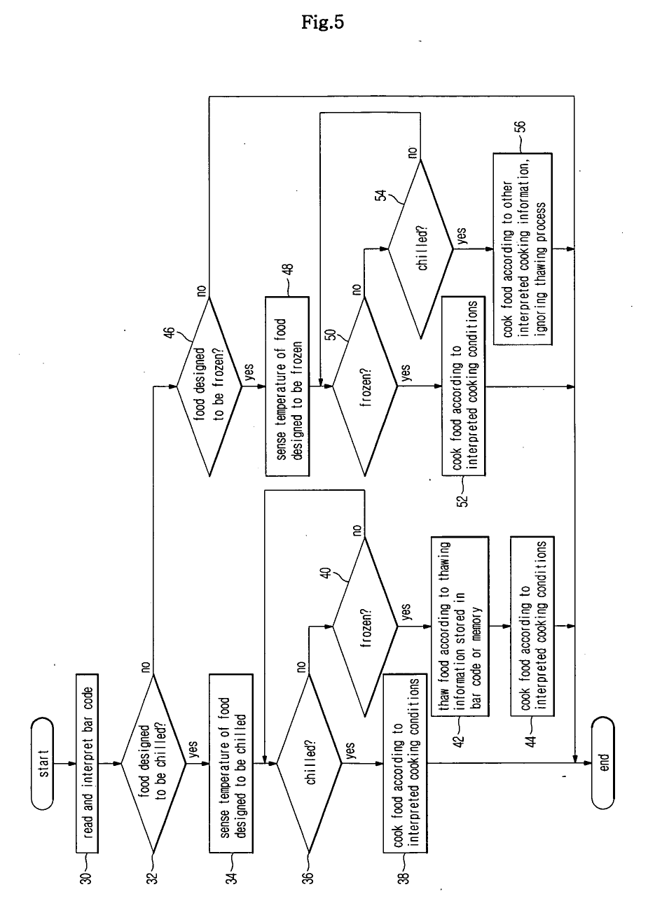

Now, a cooking method according to an embodiment of the present invention will be described with reference to FIG. 5. When a user brings a bar code printed on a food package to the bar-code reader 16, in operation 30, the bar-code reader 16 reads the bar code, and the control unit 20 interprets cooking information stored in the bar code (and also interprets thawing information according to circumstances) using the interpreting rules.

Upon completion of the interpretation of the bar code in operation 30, the process moves to operation 32 where the control unit 20 determines, referring to the kinds of food, whether the food to be cooked is designed to be chilled. When it is determined that the food to be cooked is designed to be chilled in operation 32, the process moves to operation 34 where the temperature of the food designed to be chilled is measured by the temperature sensor, from operation 34, the process moves to operation 36 where based upon the measured temperature, it is determined whether the temperature of the food designed to be chilled is within the chilled storage range, i.e., the food designed to be chilled is in chilled storage. When it is determined that the food designed to be chilled is in chilled storage in operation 36, the process moves to operation 38, where a cooking process is performed according to the interpreted cooking conditions. At this time, the cooking process is performed according to the cooking conditions, ignoring the thawing information, even though the bar code storing the thawing information as shown in FIG. 3 is read.

When it is determined in operation 36 that the food designed to be chilled is not in the chilled storage the process moves to operation 40, where it is determined whether the temperature of the food designed to be chilled is within the frozen storage range, i.e., the food designed to be chilled is in frozen storage). When it is determined that the food designed to be chilled is not in frozen storage in operation 40, the process returns to operation 36. When it is determined that the food designed to be chilled is in frozen storage in operation 40, the process moves to operation 42, where a thawing process is performed according to the thawing information stored in the bar code or the memory, and from operation 42, the process moves to operation 44 where a cooking process is performed according to the interpreted cooking conditions (a cooking mode, a cooking time, a power level).

Specifically, when the bar code used for cooking is the bar code as shown in FIG. 3, the thawing process is performed according to the thawing information stored in the bar code, since the thawing information is stored in the bar code, and then the cooking process is performed. When the bar code used for cooking is the bar code as shown in FIG. 3, on the other hand, the thawing process is performed according to the thawing information stored in the memory 23, since the thawing information is not stored in the bar code, and then the cooking process is performed.

When the thawing process is performed using the thawing information stored in the memory 23, the thawing information of the food designed to be chilled having the food name confirmed by interpreting the bar code is searched in the memory 23, and then the magnetron 21 is driven at the power level of the searched thawing information for the thawing time of the searched thawing information to thaw the food designed to be chilled, which is frozen.

As can be easily understood from the above description, food is not directly cooked based on the interpreted cooking conditions when the food, designed to be chilled, is frozen. The food designed to be chilled, which is frozen, is thawed according to the thawing information stored in the bar code or the memory 23 such that the state of the food designed to be chilled, which is frozen, is similar to the chilled storage state of the food designed to chilled, and is then cooked based on the cooking conditions. Consequently, the food is optimally cooked.

Further, as shown in FIG. 5, when it is determined in operation 32 that the food to be cooked is not designed to be chilled, the process moves to operation 46, where it is determined whether the food to be cooked is designed to be frozen. When it is determined that the food to be cooked is not designed to be frozen, it is determined that it is unnecessary for the present invention to be applied to the food to be cooked, or an error occurs during the bar code reading or interpretation, and the process is terminated.

On the other hand, when it is determined that the food to be cooked is designed to be frozen in operation 46, the process moves to operation 48 where the temperature of the food designed to be frozen is measured by the temperature sensor, and from operation 48, the process moves to operation 50, where it is determined whether the temperature of the food designed to be frozen is within the frozen storage range, i.e., the food designed to be frozen is in frozen storage. When it is determined that the food designed to be frozen is in frozen storage in operation 50, the process moves to operation 52, where a cooking process is preformed according to the interpreted cooking conditions. That is, the bar code storing the thawing information as shown in FIG. 3 is read such that the food is thawed according to the thawing information. After the thawing process is completed, the food is cooked according to the cooking conditions.

When it is determined in operation 50 that the food designed to be frozen is not in frozen storage, the process moves to operation 54, where it is determined whether the temperature of the food designed to be frozen is within the chilled storage range, i.e., the food designed to be frozen is in chilled storage. When it is determined that the food designed to be frozen is not in chilled storage in operation 54, the process returns to operation 50. When it is determined that the food designed to be frozen is in chilled storage in operation 54, the process moves to operation 56, where a cooking process is carried out according to the other interpreted cooking conditions without performing a thawing process (i.e., ignoring the thawing information stored in the bar code).

As can be easily understood from the above description, food is not directly cooked based on the interpreted cooking conditions when the food, designed to be frozen, is chilled. The food is cooked according to the other cooking conditions excluding the thawing information. Consequently, the food is optimally cooked.

In this embodiment, kinds of food, food name, thawing information, and various cooking conditions are included in the cooking information. It is possible, however, that only the thawing information and the cooking conditions are included in the cooking information.

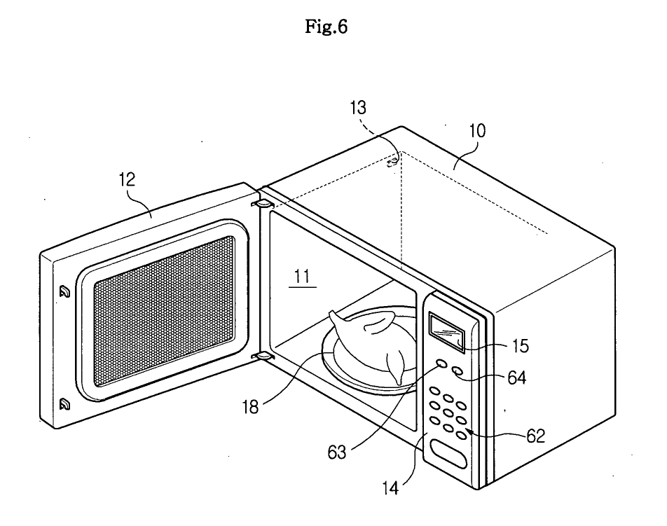

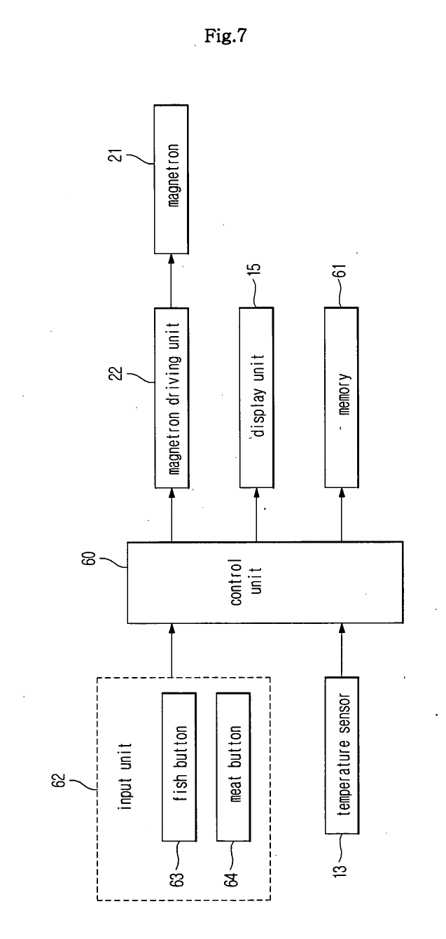

As shown in FIGS. 6 and 7, a microwave oven according to another embodiment of the present invention, comprising food buttons disposed at an input unit 62 for a user to select food to be cooked. Names of food to be cooked (for example, fish button 63 and meat button 64) are printed on the food buttons so that the user can easily select the food to be cooked.

However, the selection of food to be cooked may be performed in other manners. For example, a direction movement button (not shown) and an enter button (not shown) may be disposed at the input unit 62. In this case, the user pushes the direction movement button so that various kinds of food to be cooked are sequentially displayed on the display unit 15, and, when the food that the user wishes to cook is displayed on the display unit 15, the user pushes the enter button to select the displayed food.

Also, the microwave oven according to the second embodiment of the present invention comprises a memory 61 to store cooking information and thawing information of food designed to be chilled, and cooking information of food designed to be frozen. In this case, food to be cooked is classified into food designed to be chilled and food designed to be frozen, which are stored in the memory, and cooking information is set for each food to be cooked. Cooking information of food designed to be chilled is set on the premise that the food designed to be chilled is generally in the chilled storage, and cooking information of food designed to be frozen is set on the premise that the food designed to be frozen is generally in the frozen storage. Consequently, thawing information is not included in the cooking information of the food designed to be chilled, and therefore, thawing information of the food designed to be chilled is separately stored. On the other hand, thawing information is included in the cooking information of the food designed to be frozen. In this case, the thawing information comprises a thawing time and a power level, which are necessary to thaw the food designed to be chilled or the food designed to be frozen.

In this embodiment, food to be cooked is classified into food designed to be chilled and food designed to be frozen, which are stored, and a control unit 60 determines whether food to be cooked, which has arbitrary cooking information, is food designed to be chilled or food designed to be frozen. However, it is possible that kinds of food, by which it is determined whether food to be cooked is food designed to be chilled or food designed to be frozen, is included together with the cooking information such that the control unit 60 confirms the kind of food having arbitrary cooking information.

Also, the control unit 60 controls the respective components of the microwave oven such that a cooking process is performed according to the cooking information of the corresponding food stored in the memory 61 when the user selects the food to be cooked.

As can be seen from the above description, the first embodiment, in which the cooking information for automatic cooking is stored in the bar code, is different from the second embodiment, in which the cooking information for automatic cooking is stored in the memory 61. Furthermore, the thawing information is stored in the barcode or the memory 23 according to the first embodiment, and the thawing information is stored only in the memory 61 according to the second embodiment. Other components of the microwave oven used in the second embodiment are identical to those of the microwave oven according to the first embodiment described with reference to FIGS. 1 and 2 (except the description of the bar-code reader 16 and the memory 23 shown in FIG. 2).

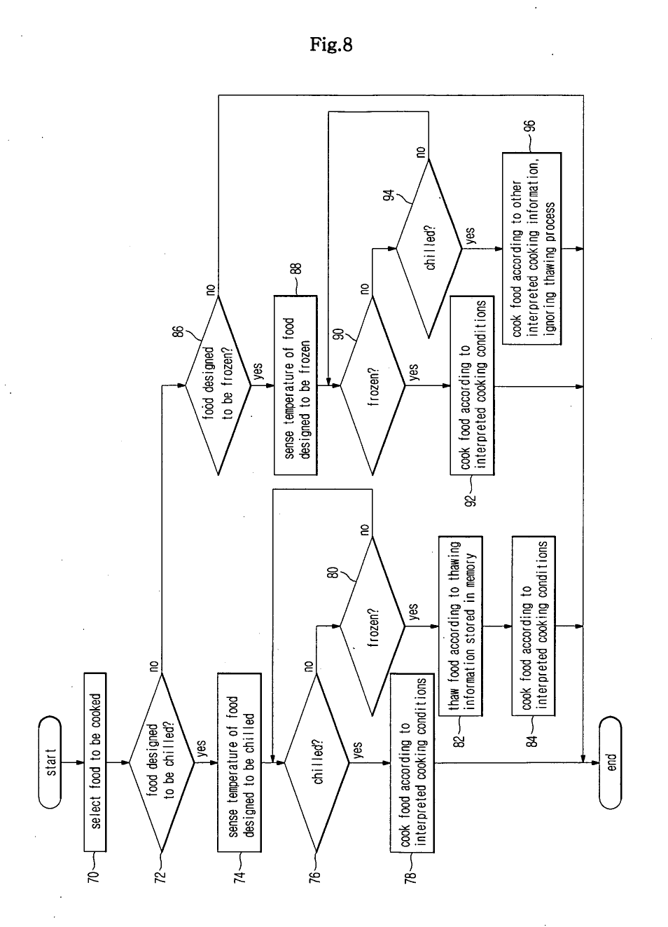

Now, a cooking method according to a second embodiment of the present invention will be described with reference to FIG. 8. When a user puts food to be cooked into the cooking chamber, in operation 70, the user pushes the food buttons of the input unit to select food to be cooked, the control unit searches for the cooking information of the corresponding food to be cooked in the memory, and in operations 72 and 86, it is respectively determined whether the food to be cooked is food designed to be chilled or food designed to be frozen, and based upon the determination, either operations 74-84 or operations 88-96 are performed. The second embodiment is identical to the first embodiment in that food designed to be chilled is thawed or food designed to be frozen is not thawed before cooking depending upon the state of food to be cooked. Other parts of Operations 74-84 and 88-96 are identical to the first embodiment. However, the matters related to the bar code in the first embodiment are not applied to the second embodiment. Specifically, the first embodiment is different from the second embodiment in that the thawing information stored in the memory is used in operation 82, in the second embodiment, and the thawing information stored in the bar code is used in the first embodiment.

In the embodiments of the present invention, food to be cooked is classified into food designed to be chilled and food designed to be frozen. However, the present invention may be applied to room-temperate storage food. This is because cooking of room-temperate storage food, which is frozen, has the same problem as cooking of food designed to be chilled, which is frozen.

As apparent from the above description, a cooking process is performed based on the current storage state of the food to be cooked when the current storage state of the food is different from the predetermined storage state of the food, i.e., when the food, designed to be chilled, is frozen, or the food, designed to be frozen, is chilled. Consequently, the present invention has the effect of accomplishing optimal cooking.

Specifically, in the case that the cooking process is automatically performed using the cooking information stored in the bar code or the memory, when the food, designed to be chilled, is frozen, it is determined that it is inappropriate to cook the food according to the cooking information, and the food is thawed before cooking, and, when the food, designed to be frozen, is chilled, the food is cooked without thawing the food. Consequently, the present invention has the effect of accomplishing appropriate cooking.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A cooking method comprising:
reading and interpreting a bar code, indicated on a package of the food to be cooked, storing kinds of food and cooking information for the food to be cooked;
sensing a temperature of the food to be cooked to confirm the stored state of the food to be cooked; and
thawing the food to be cooked according to thawing information wherein when the kind of food for the food to be cooked is food designed to be chilled and the food to be cooked is frozen, and performing a cooking process based on the cooking information.

2. The cooking method according to claim 1, further comprising:
determining that the food to be cooked is in a chilled storage when the temperature of the food to be cooked is within a predetermined chilled storage range; and
determining that the food to be cooked is in a frozen storage when the temperature of the food to be cooked is within a predetermined frozen storage range.

3. The cooking method according to claim 1, wherein the thawing information includes a thawing time set for each food to be cooked or a power level of a cooking apparatus.

4. The cooking method according to claim 1, wherein the thawing information is stored in the bar code.

5. The cooking method according to claim 1, further comprising:
setting the thawing information for each food to be cooked and storing in a memory of a cooking apparatus;
storing food name information in the bar code; and
confirming that the thawing information of the food to be cooked by interpreting the bar code in the cooking apparatus to confirm the name of the food to be cooked and searching for thawing information of the food to be cooked having the corresponding food name in the memory.

6. The cooking method according to claim 1, further comprising:
performing a cooking process based on the cooking information without thawing the food to be cooked, when the kind of food for the food to be cooked is food designed to be chilled and the food to be cooked is chilled.

7. A cooking method comprising:
reading and interpreting a bar code, indicated on a package of food to be cooked, storing kinds of food, cooking information, and thawing information for the food to be cooked;
sensing a temperature of the food to be cooked to confirm the stored state of the food to be cooked; and
performing a cooking process based on the other cooking information without thawing the food to be cooked, when the kind of food for the food to be cooked is food designed to be frozen and the food to be cooked is chilled.

8. The cooking method according to claim 7, further comprising:
determining that the food to be cooked is in a chilled storage when the temperature of the food to be cooked is within a predetermined chilled storage range; and
determining that the food to be cooked is in a frozen storage when the temperature of the food to be cooked is within a predetermined frozen storage range.

9. The cooking method according to claim 7, further comprising:
thawing the food to be cooked according to the thawing information, when the kind of food for the food to be cooked is food designed to be frozen and the food to be cooked is frozen, and performing a cooking process based on the cooking information.

10. A cooking apparatus comprising:
a bar-code reader to read a bar code, indicated on a package of food to be cooked, storing kinds of food and cooking information for the food to be cooked;
a temperature sensor to sense a temperature of the food to be cooked;
a control unit to interpret the kind of food and cooking information read by the bar-code reader, to confirm a stored state of the food to be cooked using the temperature of the food to be cooked, and, to control the food to be thawed and cooked based on the cooking information when the food to be cooked, designed to be chilled, is frozen; and
a driving unit to perform a cooking process according to a control command transmitted from the control unit.

11. The cooking apparatus according to claim 10, wherein the control unit further determines that the food to be cooked is in chilled storage when the temperature of the food to be cooked is within a predetermined chilled storage range and in the frozen storage when the temperature of the food to be cooked is within a predetermined frozen storage range.

12. The cooking apparatus according to claim 10, wherein the thawing information comprises a thawing time set for each food to be cooked or a power level of the driving unit.

13. The cooking apparatus according to claim 10, wherein the thawing information is stored in the bar code.

14. The cooking apparatus according to claim 10, further comprising:
a memory to store the thawing information set for each food to be cooked.

15. A cooking apparatus comprising:
a bar-code reader to read a bar code, indicated on a package of food to be cooked, storing kinds of food, cooking information, and thawing information for the food to be cooked;
a temperature sensor to sense a temperature of the food to be cooked;
a control unit to interpret the cooking information and the kinds of food read by the bar-code reader, to confirm the stored state of the food to be cooked using the temperature of the food to be cooked, and to control the food to be cooked based on the cooking information without thawing the food to be cooked, when the kind of food for the food to be cooked is food designed to be frozen and the food to be cooked is chilled; and
a driving unit to perform a cooking process according to a control command from the control unit.

16. The cooking apparatus according to claim 15, wherein the control unit further determines that the food to be cooked is in a chilled storage when the temperature of the food to be cooked is within a predetermined chilled storage range, and in a frozen storage when the temperature of the food to be cooked is within a predetermined frozen storage range.

17. A cooking method comprising:
storing kinds of food, cooking information, and thawing information for food to be cooked in a memory of a cooking apparatus;
searching for the cooking information of food to be cooked, which is selected by a user, in the memory;
sensing a temperature of the food to be cooked to confirm a stored state of the food to be cooked; and
thawing the food to be cooked according to the thawing information stored in the memory when the kind of food for the food to be cooked is food designed to be chilled and the food to be cooked is frozen, and performing a cooking process based on the cooking information stored in the memory.

18. The cooking method according to claim 17, further comprising:
performing a cooking process based on the cooking information without thawing the food to be cooked when the kind of food for the food to be cooked is food designed to be chilled and the food to be cooked is chilled.

19. A cooking method comprising:
storing kinds of food, cooking information, and thawing information for food to be cooked in a memory of a cooking apparatus;
searching for the cooking information of food to be cooked, which is selected by a user, in the memory;
sensing a temperature of the food to be cooked to confirm a stored state of the food to be cooked; and
performing a cooking process based on the other cooking information stored in the memory excluding the thawing information when the kind of food for the food to be cooked is food designed to be frozen and the food to be cooked is chilled.

20. The cooking method according to claim 17 further comprising:
determining that the food to be cooked is in a chilled storage when the temperature of the food to be cooked is within a predetermined chilled storage range; and
determining that the food to be cooked is in a frozen storage when the temperature of the food to be cooked is within a predetermined frozen storage range.

21. The cooking method according to claim 19, further comprising:
determining that the food to be cooked is in a chilled storage when the temperature of the food to be cooked is within a predetermined chilled storage range; and
determining that the food to be cooked is in a frozen storage when the temperature of the food to be cooked is within a predetermined frozen storage range

22. A cooking apparatus comprising:
a memory to store kinds of food, cooking information, and thawing information for food to be cooked;
a temperature sensor to sense a temperature of the food to be cooked;
a control unit to control the food to be thawed according to the thawing information and then the food to be cooked based on the cooking information, when the kind of food for the food to be cooked is food designed to be chilled and the food to be cooked is frozen; and
a driving unit to perform a cooking process according to a control command from the control unit.

23. A cooking apparatus comprising:
a memory to store kinds of food, cooking information, and thawing information for food to be cooked;
a temperature sensor to sense a temperature of the food to be cooked;
a control unit to control the food to be cooked based on the other cooking information excluding the thawing information without thawing the food to be cooked, when the kind of food for the food to be cooked is food designed to be frozen and the food to be cooked is chilled; and
a driving unit to perform a cooking process according to a control command transmitted from the control unit.
